(19) United States
(12) Patent Application Publication
(10) Pub. No.: US 2016/0108291 A1
(43) Pub. Date: Apr. 21, 2016

(54) PRESSURE-SENSITIVE ADHESIVE FILM AND USE OF SAME FOR PROTECTING SURFACES

(71) Applicant: NOVACEL, Deville-Les-Rouen (FR)

(72) Inventors: Jean-Loup MASSON, Bois-Guillaume (FR); Farah DE FILIPPIS, Scotteville-les-Rouen (FR)

(73) Assignee: NOVACEL, DEVILLE-LES-ROUEN (FR)

(21) Appl. No.: 14/889,446

(22) PCT Filed: May 15, 2014
(86) PCT No.: PCT/FR2014/051137

§ 371 Date: Nov. 6, 2015

(30) Foreign Application Priority Data
May 16, 2013 (FR) 1354382

(51) Int. Cl. C09J 7/02

(52) U.S. Cl. CPC C09J 7/0289; C09J 7/0275; C09J 7/0246; C09J 2201/606; C09J 2423/046; C09J 2423/106; C09J 2423/166; C09J 2433/00; C09J 2421/00

(57) ABSTRACT

The invention relates to a pressure-sensitive adhesive film that comprises a support coated with a pressure-sensitive adhesive, said support comprising an expanded polyolefin layer. Such an adhesive film is suitable for the temporary protection of surfaces.

The invention relates to the field of the temporary protection of surfaces. More particularly, the invention relates to a pressure-sensitive adhesive film having an expanded layer formulated and suitable for use in the field of the temporary protection of surfaces.

It is today possible to produce blown, or cast, plastic films of“low” density (i.e. a density around 20 to 40% lower than that of the same films made with the same material but by a “conventional” technology) in thicknesses that may be less than 100 μm. This low density is obtained by the use of blowing agents, in particular by injecting gas into a layer of the film from an extrusion screw. Such plastic films (of low density, but often having greater thicknesses) are generally used for packaging manufactured products.

Blown films are typically produced from polyethylene. By way of example, reference may be made to patent applications WO 97/20888 and WO 01/92403.

Furthermore, pressure-sensitive surface protection films are now very common. These films are in particular used for protecting lacquered or unlacquered, metallic or nonmetallic surfaces such as for example motor vehicle bodywork, or else plastic surfaces in sheet form (PMMA, PVC, PC, PETg, etc.) or profiled form, laminated surfaces, varnished surfaces, coated or uncoated glass, carpet, etc. One of the requirements that surface protection films must meet is to leave the least amount of marks, pollution or adhesive residues possible on the protected surfaces once the film is removed. This requires specific formulations of films, adhesives and optionally inks and varnishes, and also particular processes for assembling these components. The “low” density films, mentioned above, are not however today formulated to meet the mechanical, thermal, qualitative or natural aging requirements of the temporary surface protection self-adhesive film market. However these supports have an ecological advantage, due to the material saving observed.

Pressure-sensitive surface protection films generally comprise a support layer and an adhesive layer formed thereon. They may be prepared by coating an adhesive in the solvent phase or in the aqueous phase, or via a dry (hot-melt or warm-melt) method, on the support layer, or by coextrusion of the support layer and of the adhesive layer in a single operation. As examples, mention may be made of the films described in the following documents: EP-A-0 519 278; U.S. Pat. No. 5,925,456; FR-A-2 969 626; and DE-A-10 2005 055 913.

Furthermore, when a surface protection film is prepared by the coating technique, the adhesive layer is always coated on a smooth surface (or relatively smooth surface, for example having a gloss greater than 70, as measured according to the ASTM 2457 standard). The support layer in general has two smooth surfaces, but it is possible for the upper layer of the support, the one which is not in contact with the adhesive, to be rough (gloss of less than 70, as measured according to the ASTM 2457 standard), for particular technical requirements (for example a modification of the friction coefficient).

The “low” density films, due to the presence of gas within the plastic, may have a substantial roughness on each of their surfaces. This roughness, obtained without abrasive agents, such as mineral fillers, makes it possible to more easily convey the protected surfaces without risk of scratching or degradation of the conveying tools. On the other hand, these same surfaces, as they are structured, are never coated with an adhesive since that would give rise to inhomogeneous deposits and consequently risks of substandard performance of the adhesive-coated products (including adhesive residues on the protected surface).

It has now been discovered, and this is the basis of the invention, that it is possible to prepare a pressure-sensitive adhesive film by coating an “expanded” support layer, of low density, with a pressure-sensitive adhesive.

Thus, according to a first aspect, the invention relates to a pressure-sensitive adhesive film that comprises a support coated with a pressure-sensitive adhesive, said support comprising at least one expanded polyolefin layer, said polyolefin being selected from a radical low-density polyethylene, a linear polyethylene, a polypropylene, a copolymer of ethylene and polypropylene, or a mixture of these compounds. The expression “mixture of these compounds” is understood within the meaning of the present invention to be a mixture of several polyolefins of the same type, or of one or more polyolefin(s) of a first type with one or more polyolefin(s) of one or more other types.

Advantageously, the radical low-density polyethylene (rLDPE) has a density, measured according to the ASTM D1505 standard, in the range from 0.910 to 0.930, and a flow index, measured according to the ASTM D1238 standard (190° C./2.16 kg), in the range from 0.3 to 10 dg/min. The linear polyethylene (linear PE) is a copolymer of ethylene and of a C₃-C₈ olefinic monomer, such as propene, butene, hexene, methylpentene or octene. Advantageously, the linear PE has a density, measured according to the ASTM D1505 standard, in the range from 0.858 to 0.961 and a flow index, measured according to the ASTM D1238 standard (190° C./2.16 kg), in the range from 0.05 to 10 dg/min. The copolymer of ethylene and propylene (EPM) advantageously has a density, measured according to the ASTM D1505 standard, in the range from 0.860 to 0.910 and a propylene content in the range from 25 to 60% by weight.

The aforementioned rLDPE, linear PE and EPM may be either of metallocene or Ziegler-Natta catalysis.

Advantageously, the polypropylene has a density, measured according to the ASTM D1505 standard, in the range from 0.860 to 0.920, and a flow index, measured according to the ASTM D1238 standard (230° C./2.16 kg), in the range from 0.3 to 10 dg/min.

The support of the pressure-sensitive adhesive film according to the invention is of single-layer type or multilayer type, preferably the support is a multilayer support and advantageously comprises 3, 5, 7 or 9 layers.

According to one embodiment of the invention, the support is of single-layer type, which essentially consists of expanded polyolefin as defined above. The expression “essentially consists of” is understood to mean the fact that the support layer comprises no other constituents capable of affecting the mechanical and adhesive properties of the protective film. The layer may nevertheless contain one or more additives commonly used in the manufacture of pressure-sensitive adhesive films, selected for example from matting agents, in particular antiblocking agents; slip agents; colorants; UV stabilizers; UV barriers; antioxidants; anti-aging agents; and blowing agents. Advantageously, the expanded polyolefin layer comprises one or more additives selected from antiblocking agents, colorants and antioxidants.

According to another embodiment of the invention, the support is of multilayer type, and preferably comprises 3, 5, 7 or 9 layers. In this embodiment, one or more layers of the support consist(s) essentially of expanded polyolefin (and may each comprise, as indicated above, one or more conventional additives, advantageously one or more additives selected from antiblocking agents, colorants and antioxidants). Advantageously, the number of layers of the support is an odd number, and at least the central layer of the support essentially consists of expanded polyolefin. The other layer(s) of the support which is (are) not expanded, advantageously consist(s) essentially (1) of a polyolefin, (2) of a synthetic rubber, (3) of a copolymer of ethylene and vinyl acetate, or of a mixture of these compounds. The expression “essentially consists of” used here has the same meaning as above. The expression “mixture of these compounds” is understood to mean a mixture of several compounds of the same type [(1), (2) or (3)], or of one or more compounds of a first type with one or more compounds of one or more other types.

The polyolefin used for the non-expanded layer(s) is advantageously selected from a radical polyethylene (PE), a linear polyethylene (PE), a polypropylene (PP) or a copolymer of ethylene and propylene (EPM).

The radical PE advantageously has a density, measured according to the ASTM D1505 standard, in the range from 0.910 to 0.930, and a flow index, measured according to the ASTM D1238 standard (190° C./2.16 kg), in the range from 0.3 to 10 dg/min. The linear PE is a copolymer of ethylene and of a C₃-C₈ olefinic monomer, such as propene, butene, hexene, methylpentene or octene. It may be high, medium, low or very low density, i.e. with a density, measured according to the ASTM D1505 standard, in the range from 0.858 to 0.961 and a flow index, measured according to the ASTM D1238 standard (190° C./2.16 kg), in the range from 0.05 to 10 dg/min. All the aforementioned polyethylenes may be either of metallocene or Ziegler-Natta catalysis.

The PP has a density, measured according to the ASTM D1505 standard, advantageously in the range from 0.860 to 0.920, and a flow index, measured according to the ASTM D1238 standard (230° C./2.16 kg), in the range from 0.3 to 10.

The EPM has a density, measured according to the ASTM D1505 standard, advantageously in the range from 0.860 to 0.910 and a propylene content in the range from 25 to 60% by weight. The PP and the EPM may be either of metallocene or Ziegler-Natta catalysis.

The synthetic rubber capable of being used in the non-expanded layer(s) is advantageously selected from a styrene-ethylene-butylene-styrene copolymer (SEBS); a styrene-ethylene-propylene-styrene copolymer (SEPS); a styrene-isoprene-styrene copolymer (SIS); an asymmetric SIS, an optionally hydrogenated vinyl derivative of SIS; a styrene-isoprene-butadiene-styrene copolymer (SIBS); a styrene-isobutylene-styrene copolymer (SiBS); an ethylene-styrene copolymer (ES); and mixtures of these copolymers.

The SEBS, SEPS, SIS, SIBS and SiBS copolymers advantageously have a styrene content less than or equal to 50% by weight, preferably in the range from 5 to 45% by weight; also advantageously, these polymers have a content of SEB, SEP, SI, SIB or SiB diblocks less than or equal to 70% by weight. The ES copolymers advantageously have a styrene content in the range from 5 to 85% by weight, and preferably a flow index, measured according to the ASTM 1238 standard, in the range from 0.1 to 40 dg/min.

The copolymer of ethylene and vinyl acetate (EVA) capable of being used in the non-expanded layer(s) advantageously has a vinyl acetate content less than or equal to 80% by weight, and a flow index, measured according to the ASTM D1238 standard, in the range from 0.1 to 40 dg/min.

Each support layer, including the expanded layer, may contain one or more additives such as matting agents, in particular antiblocking agents; slip agents; colorants; UV stabilizers; UV barriers; antioxidants; anti-aging agents; blowing agents; and additives that modify the degree of adhesion of the layer. These additives, when they are present, represent about 0.1% to about 25% by weight of the total weight of each layer. Additives that are particularly advantageous within the context of the present invention are the matting agents, in particular the antiblocking agents; the (primary or secondary) antioxidants; and the anti-aging agents.

Among the matting agents, mention may be made of:
matting agents that are incompatible with low-density PEs such as acrylic-grafted polyethylenes or polyethylene salts;
antiblocking agents, such as silica and derivatives thereof, talc and derivatives thereof, mica and derivatives thereof, low-density linear polyethylenes containing a filler such as calcium carbonate, talc, titanium dioxide or a mixture of these compounds.

Among the blowing agents, mention may be made of endothermic agents (for example citric acid and derivatives thereof or sodium bicarbonate) and exothermic agents.

Among the anti-aging agents, mention may be made of sterically hindered amines also referred to as HALS (hindered amine light stabilizers).

It is possible to use several additives of the same type.

The support used within the context of the invention may be prepared by extrusion of the layer(s) that form(s) it, in particular by cast film coextrusion or blown film coextrusion. These techniques are well known to a person skilled in the art, and are described for example in the book “Encyclopedia of Chemical Technology” (Kirk-Othmer), 1996, volume 19, pages 290-316. The expanded layer(s) of the support may in particular be introduced into the support according to the process and with the aid of the device described in application WO 2005/007729, the content of which is incorporated into the present application in its entirety. The expanded layer(s) of the support may also be formed in the support by introducing a fluid in the supercritical state into the extrusion screw(s). The formation of fine bubbles may be promoted by the addition of fillers (in particular antiblocking agents or blowing agents).

The pressure-sensitive adhesive film according to the invention is obtained by coating the support described above with a pressure-sensitive adhesive, in particular an adhesive of acrylic type, as an emulsion or solvent-based; an adhesive of rubber type, of natural or synthetic origin; or else an adhesive of polyisobutylene or EVA type. The well-known coating techniques are carried out within the context of the invention. Mention may be made by way of example, nonlimitingly, of threaded bar (or Mayer bar) coating, direct gravure coating or indirect gravure coating (porous metering roll), and curtain coating technologies.

According to one embodiment of the invention, the pressure-sensitive adhesive film is obtained by coating a rubber (natural or synthetic rubber or mixture of natural and/or synthetic rubber(s)) adhesive, an EVA-based adhesive, or an acrylic adhesive on the support. Particularly advantageously, the adhesive used within the context of the invention is a (natural or synthetic) rubber adhesive or an acrylic adhesive. According to one embodiment of the invention, the rubber adhesive or the acrylic adhesive is crosslinked.

A rubber adhesive capable of being used within the context of the invention is as described below. Particularly advantageously, the rubber adhesive is obtained by mixing around 5% to 40% by weight (solids content) of a formulation containing:
100 parts by weight of a natural and/or synthetic rubber, or of a mixture of natural and/or synthetic rubber(s),
0 to 150 parts by weight of one or more tackifying resins,
0 to 80 parts by weight of a plasticizing agent,
0 to 15 parts by weight, preferably 0.1 to 10 parts by weight, of a crosslinker, and
0 to 5 parts by weight of one or more anti-aging agents,
   in a hydrocarbon-based solvent such as toluene, gasoline, hexane or a mixture of these solvents.

When the rubber adhesive contains no crosslinker, the support is coated with a bonding primer layer, typically having a thickness of about 1 μm, before application of said adhesive.

The synthetic rubber capable of being used in the rubber adhesive is advantageously selected from a styrene-ethylene-butylene-styrene copolymer (SEBS); a styrene-ethylene-propylene-styrene copolymer (SEPS); a styrene-butadiene-styrene copolymer (SBS); a styrene-isoprene-styrene copolymer (SIS); an asymmetric SIS, an optionally hydrogenated vinyl derivative of SIS; a styrene-isoprene-butadiene-styrene copolymer (SIBS); a styrene-isobutylene-styrene copolymer (SiBS); an ethylene-styrene copolymer (ES); and mixtures of these copolymers with or without natural rubber.

The tackifying resin capable of being used in the rubber adhesive is advantageously a thermoplastic resin of low molecular weight that is natural or synthetic, or non-hydrogenated, completely or partially hydrogenated or a mixture thereof, preferably of C5 or C9 or a C5/C9 mixture.

The plasticizing agent capable of being used in the rubber adhesive is advantageously a plasticizing oil or a plasticizing resin preferably of weakly polar nature, suitable for plasticizing elastomers, in particular thermoplastic elastomers. At ambient temperature (23° C.), these more or less viscous oils are liquids. For example, the plasticizing oil is selected from the group consisting of paraffinic, naphthenic or aromatic oils.

The anti-aging agent capable ofbeing used in the rubber adhesive is as defined above.

According to another embodiment of the invention, the pressure-sensitive adhesive film is obtained by coating an acrylic adhesive on the support.

An acrylic adhesive capable of being used within the context of the invention typically comprises:
100 parts by weight of one or more aqueous acrylic dispersion(s) obtained by emulsion polymerization of a mixture of monomers comprising:
   40 to 100% by weight of a monomer having a low glass transition temperature (Tg≦0° C.), advantageously selected from 2-ethylhexyl acrylate, ethyl acrylate, butyl acrylate, iso-octyl acrylate, octyl acrylate, or mixtures thereof;
   5 to 45% of secondary monomer, having a higher glass transition temperature (Tg>0° C.), advantageously selected from methyl acrylate, methyl methacrylate, vinyl acetate, ethyl acetate, styrene, acrylonitrile, or mixtures thereof,
   2 to 40% by weight of functionalized reactive monomer(s) advantageously selected from hydroxyethyl acrylate, acrylic acid, methacrylic acid, itaconic acid, citraconic acid, fumaric acid, maleic acid and derivatives of these acids, acrylic and/or methacrylic acid being preferred;
   0 to 80 parts by weight, preferably 15 to 60 parts by weight, of a tackifying resin in dispersion; and
   one of more agents such as surfactants, antifoaming agents, etc., to facilitate the dispersing and use of the acrylic adhesive;
   the sum of the various constituents of each acrylic dispersion being equal to 100%;
0.05 to 30 parts by weight, preferably 0.1 to 15 parts by weight, of a crosslinker; and
0 to 5 parts by weight of one or more anti-aging agents.

Entirely by way of indication, mention may be made of the acrylic adhesives described in patent application WO 2005/111101.

The tackifying resins in dispersion capable of being used in the acrylic adhesive are well known to a person skilled in the art and may be selected in particular from rosin resins, terpene-phenol resins, and the resins obtained from C₅, (C₅)₂ and/or C₉ petroleum cuts that may then be partially or completely hydrogenated. These resins advantageously have a softening point, measured according to the ring and ball method (ASTM E 28 standard), of less than or equal to 140° C., generally in the range from 75 to 140° C., preferably in the range from 75 to 125° C. By way of example, mention may be made of the products sold under the name Dermulsene® (DRT), Permatac® (DRT) and Tacolyn® (Eastman).

Advantageously, the crosslinker used in the rubber adhesive or the acrylic adhesive of the invention is an isocyanate crosslinker, in particular an aliphatic isocyanate crosslinker or an alicyclic isocyanate crosslinker. By way of example of an aliphatic isocyanate crosslinker, mention may be made of an aliphatic diisocyanate such as hexamethylene diisocyanate; a trimer of such a diisocyanate; an aliphatic triisocyanate; and also a polymer derived from these homopolymerized or copolymerized monomers, or derived from the addition of a polyol or of a polyamine with one or more of these monomers, the polyol or the polyamine possibly being a polyether, a polyester, a polycarbonate, or a polyacrylate. By way of example of an alicyclic isocyanate crosslinker capable of being used within the context of the invention, mention may be made of an alicyclic diisocyanate, such as 3-isocyanatomethyl-3,5,5-trimethylcyclohexyl isocyanate (better known under the name isophorone diisocyanate or IPDI) or hydrogenated diphenylmethane diisocyanate; a trimer of such a diisocyanate; an alicyclic triisocyanate; and also a polymer derived from these homopolymerized or copolymerized monomers, or derived from the addition of a polyol or of a polyamine with one or more of these monomers, the polyol or the polyamine possibly being a polyether, a polyester, a polycarbonate, or a polyacrylate.

Other families of crosslinkers may also advantageously be used. By way of example, mention may be made of polyaziridines, polycarbodiimides or else aluminum salts.

The adhesive is advantageously coated on the support in an amount of 0.5 to 25 g/m², preferably in an amount of 0.5 to 20 g/m², more preferably in an amount of 0.5 to 16 g/m², for example in an amount of 3 to 25 g/m², 3 to 20 g/m² or else 3 to 16 g/m².

Advantageously, the support is plasma treated or corona treated before the application of the adhesive.

The pressure-sensitive adhesive film thus obtained has a thickness generally of between about 30 μm and about 200 μm, preferably between about 20 μm and about 100 μm. The support generally represents between 60% and 95% of the total thickness of the film.

This film has, before application on a surface to be protected, a peel force, measured according to the AFERA 5001 standard (180° peel and peel rate of 300 mm/min), in the range of 0 to 400 cN/cm, preferably 0 to 200 cN/cm. After application to the surface to be protected, the protective film has a peel force (measured by tensile testing according to a protocol adapted from the AFERA 5001 standard, with a peel rate ranging from 10 mm/min to 30 000 mm/min) in the range of 1 to 700 cN/cm, preferably 1 to 400 cN/cm.

The non-coated film furthermore advantageously has, on both sides:
a surface roughness R_{A}, measured according to the ISO 13565-2 standard, in the range from 0.05 to 6 μm, preferably from 0.1 to 5 μm, more preferably from 0.2 to 5 μm, and more preferably still from 0.3 to 3 μm;
a roughness Rz in the range from 0.1 to 16 μm, preferably from 0.4 to 12 μm;
a periodicity in the range from 5 to 200 μm;
a tear strength in the longitudinal direction of the film (measured by means of an ED 30/32 tear tester according to the NF EN ISO 6383-2 standard) greater than or equal to 250 mN, preferably in the range from 250 to 25000 mN.

The pressure-sensitive adhesive film according to the invention is particularly suitable for the temporary protection of surfaces, in particular the temporary protection of bare or painted metal surfaces, plastic sheets, laminates, carpets, plastic profiles, varnished plastic surfaces and glass. Specifically, it has in particular the following technical advantages:
it is ecological (less weight of material for the same thickness and possibility of depositing less adhesive for an adhesion similar to customary films);
it adheres better to the surface to be protected, due to the deposition differentials generated by the roughness of the support (the deposition at one point may be greater than the average deposition, and therefore the adhesion is greater);
it unwinds with less force and with less noise relative to products of the same thickness and the same adhesive mass;
it enables, due to its natural roughness, a better slip when it is necessary to separate two industrial sheets, protected on each side, and stacked on top of one another, and this being without the use of abrasive mineral fillers.

The invention is illustrated by the examples hereinbelow, given purely by way of indication.

### EXAMPLE 1

### Adhesive Film Composed of a Rubber-Coated Three-Layer Support

An adhesive film having a thickness of 80 μm was prepared in the following manner. Firstly, a support film was manufactured using three-layer blown-film coextrusion equipment. The following were thus introduced:
into extruder no. 1, a 98/2 mixture by weight of radical polyethylene having a density of 0.924 and a flow index of 0.7 and of an antiblocking masterbatch ABPE 50N (Polytechs);
into extruder no. 2, a 70/14/15/1 mixture by weight of radical polyethylene having a density of 0.924 and a flow index of 0.7, of a white coloring agent (TiO₂), CL8000 (A. Schulman), of an antiblocking agent, ME50024 (Multibase) and of antioxidant Polybatch UV1952 (A. Schulman); this intermediate layer was 64% expanded by injection of nitrogen in the supercritical fluid state into the mixture; and
into extruder no. 3, an 84/12/2 mixture by weight of radical polyethylene having a density of 0.924 and a flow index of 0.7, of a black coloring agent (carbon black), 1423HF1 (A. Schulman), and of an antiblocking masterbatch ABPE 50N (Polytechs).

An extrusion aid, the processing aid masterbatch POLYBATCH® NATURAL AMF 705 HF (A. Schulman), was used to facilitate the extrusion.

The extruded film thus obtained has a thickness of 75 microns for a total spread of 55 g/m². The surface intended to be in contact with the adhesive layer was then corona treated.

The extruded film has, on the side not corona treated, an Ra of 2.3 μm (0.10 μm) and an Rz of 12 μm (±0.6 μm) measured using a HOMMEL TESTER T1000 roughness meter.

An adhesive composition was furthermore prepared by mixing, in gasoline:
100 parts by weight of CV50 SMR (standard Malaysian rubber) natural rubber,
120 parts by weight of Wingtack 86 (Cray Valley) tackifying resin,
3 parts by weight of Irganox 1010 (Ciba) antioxidant,
1.5 parts by weight of Tinuvin 770DF (BASF) anti-aging agent,
7 parts by weight of Desmodur N3600 (Bayer) crosslinker.

The adhesive composition was coated on the support film under the standard conditions known to a person skilled in the art, so as to obtain a dry deposition of 5 g/m², equivalent to a thickness of 5 microns.

### COMPARATIVE EXAMPLE 1

### Adhesive Film Composed of a Rubber-Coated Three-Layer Support

The protocol from example 1 was repeated but without expansion of the intermediate layer originating from extruder no. 2. The non-coated film has a thickness of 55 microns.

### Film Properties

The characteristics of the non-coated films of example 1 and comparative example 1 are presented in table 1. The mechanical properties were measured using Instron equipment. The initiated tear strength was measured using an ED 30/32 (TMI) tear tester according to the NF EN ISO 6383-2 standard. The elongation at break, the force at break and the tear strength were measured in the longitudinal direction and in the transverse direction of the film.

TABLE 1

| | | Ex. 1 | Comp. Ex. 1 |
|---|---|---|---|
| | | (75 μm) | (55 μm) |
| Elongation at break | Long | 200 | 320 |
| (%) | Trans | 500 | 410 |
| Force at break | Long | 0.6 | 0.7 |
| (daN/cm) | Trans | 0.5 | 0.6 |
| Tear strength (mN) | Long | 620 | 1775 |
| | Trans | 4700 | 3950 |

The pressure-sensitive adhesive film of example 1 also has an initial peel force of 70 cN/cm (measurement by an Instron-type tensile tester at 300 mm/min and 180°, protocol adapted from the AFERA 5001 standard). This peel force is greater than that of the adhesive film of comparative example 1, which has an initial peel force of 50 cN/cm (measurement by an Instron-type tensile tester at 300 mm/min and 180°, protocol adapted from the AFERA 5001 standard).

### EXAMPLE 2

### Adhesive Film Composed of a Rubber-Coated Three-Layer Support

An adhesive film having a thickness of 70 μm was prepared in the following manner. Firstly, a support film was manufactured using three-layer blown-film coextrusion equipment.

The following were thus introduced:
into extruder no. 1, a 98/2 mixture by weight of C8 linear polyethylene having a density of 0.919 and a flow index of 1.1 and of an antiblocking masterbatch ABPE 50N (Polytechs);
into extruder no. 2, a 75/14/10/1 mixture by weight of radical polyethylene having a density of 0.924 and a flow index of 0.7, of a white coloring agent (TiO₂), CL8000 (A. Schulman), of an antiblocking agent, ME50024 (Multibase) and of antioxidant Polybatch UV1952 (A. Schulman); this intermediate layer was 40% expanded by injection of nitrogen in the supercritical fluid state into the mixture; and
into extruder no. 3, an 84/12/2 mixture by weight of C8 linear polyethylene having a density of 0.919 and a flow index of 1.1, of a black coloring agent (carbon black), 1423HF1 (A. Schulman), and of an antiblocking masterbatch ABPE 50N (Polytechs).

An extrusion aid, the processing aid masterbatch POLYBATCH® NATURAL AMF 705 HF (A. Schulman), was used to facilitate the extrusion.

The extruded film thus obtained has a thickness of 65 microns for a total spread of 52 g/m². The surface intended to be in contact with the adhesive layer was then corona treated. A polyvinyl octadecyl carbamate “release” varnish composition was coated on the second, corona-pretreated, face of the support film under the standard conditions known to a person skilled in the art, so as to obtain a monomolecular layer.

The extruded film has, on the side to be coated with varnish, an Ra of 2.4 μm (±0.10 μm) and an Rz of 16 μm (±0.5 μm) measured using a HOMMEL TESTER T1000 roughness meter.

An adhesive composition was furthermore prepared by mixing, in gasoline:
100 parts by weight of CV50 SMR (standard Malaysian rubber) natural rubber,
120 parts by weight of Wingtack 86 (Cray Valley) tackifying resin,
3 parts by weight of Irganox 1010 (Ciba) antioxidant,
1.5 parts by weight of Tinuvin 770DF (BASF) anti-aging agent,
7 parts by weight of Desmodur N3600 (Bayer) crosslinker.

The adhesive composition was coated on the support film under the standard conditions known to a person skilled in the art, so as to obtain a dry deposition of 5 g/m², equivalent to a thickness of 5 microns.

### COMPARATIVE EXAMPLE 2

The protocol from example 2 was repeated but without expansion of the intermediate layer originating from extruder no. 2 and by replacing the linear polyethylene with radical polyethylene having a density of 0.924 and a flow index of 0.7 in the outer layers originating from extruders no. 1 and no. 3. The non-coated film has a thickness of 65 microns (for a total spread of 65 g/m²).

### Film Properties

The initiated tear strength of the non-coated films of example 2 and comparative example 2, measured in the longitudinal direction and in the transverse direction using an ED 30/32 (TMI) tear tester according to the NF EN ISO 6383-2 standard, is presented in table 2.

TABLE 2

| | | Ex. 2 | Comp. Ex. 2 |
|---|---|---|---|
| | | (65 μm) | (65 μm) |
| Tear strength (mN) | Long | 4000 | 250 |
| | Trans | 14400 | 3700 |

The pressure-sensitive adhesive film of example 2 also has an initial peel force of 68 cN/cm (measurement by an Instron-type tensile tester at 300 mm/min and 180°, protocol adapted from the AFERA 5001 standard), very similar to that of the film of example 1.

### EXAMPLE 3

### Adhesive Film Composed of an Acrylic-Coated Three-Layer Support

An adhesive film having a thickness of 107 μm was prepared in the following manner. Firstly, a support film was manufactured using three-layer blown-film coextrusion equipment. The following were thus introduced:
into extruder no. 1, a 98/2 mixture by weight of radical polyethylene having a density of 0.924 and a flow index of 0.7 and of an antiblocking masterbatch ABPE 50N (Polytechs);
into extruder no. 2, a 63/20/14/2/1 mixture by weight of radical polyethylene having a density of 0.924 and a flow index of 0.7, of linear polyethylene (comonomer butene) having a density of 0.918 and a flow index of 1, of a white coloring agent (TiO₂), CL8000 (A. Schulman), of a blowing agent, hydrocerol CF5E (Clariant) and of antioxidant Polybatch UV1952 (A. Schulman); this intermediate layer was 27% expanded by injection of nitrogen in the supercritical fluid state into the mixture; and
into extruder no. 3, a 97/2/1 mixture by weight of radical polyethylene having a density of 0.924 and a flow index of 0.7, of an antiblocking masterbatch ABPE 50N (Polytechs), and of antioxidant Polybatch UV1952 (A. Schulman).

An extrusion aid, the processing aid masterbatch POLYBATCH® NATURAL AMF 705 HF (A. Schulman), was used to facilitate the extrusion.

The extruded film thus obtained has a thickness of 87 microns for a total spread of 75 g/m². The surface intended to be in contact with the adhesive layer was then corona treated.

The extruded film has, on the side not corona treated, an Ra of 1.9 μm (±0.2 μm) and an Rz of 10 μm (±0.5 μm) measured using a HOMMEL TESTER T1000 roughness meter.

An adhesive composition was furthermore prepared by mixing:
100 parts by weight of acrylic dispersion (Acronal® DS3559), and
3 parts by weight of isocyanate crosslinker (Vestanat® IPDI (Degussa)),
   so as to obtain a solids content of 50% for the composition.

The isocyanate crosslinker was introduced into the dispersion in the form of a 25% premix in ethyl acetate.

The adhesive composition was coated on the support film under the standard conditions known to a person skilled in the art, so as to obtain a dry deposition of 20 g/m², equivalent to a thickness of 20 microns.

### EXAMPLE 4

### Adhesive Film Composed of an Acrylic-Coated Three-Layer Support

The protocol of example 3 was repeated by using, in the extruder no. 2, a 75/14/10/1 mixture by weight of radical polyethylene having a density of 0.924 and a flow index of 0.7, of a white coloring agent (TiO₂), CL8000 (A. Schulman), of an antiblocking agent, ME50024 (Multibase) and of antioxidant Polybatch UV1952 (A. Schulman).

The non-coated film has a thickness of 87 microns for a total spread of 75 g/m². The surface intended to be in contact with the adhesive layer was then corona treated. The extruded film also has, on the side not corona treated, an Ra of 1.8 μm (±0.2 μm) and an Rz of 9.5 μm (±0.5 Mm) measured using a HOMMEL TESTER T1000 roughness meter.

### Film Properties

The initiated tear strength of the non-coated films of examples 3 and 4, measured in the longitudinal direction and in the transverse direction using an ED 30/32 (TMI) tear tester according to the NF EN ISO 6383-2 standard, is presented in table 3.

TABLE 3

| | | Ex. 3 | Ex. 4 |
|---|---|---|---|
| | | (87 μm) | (87 μm) |
| Tear strength (mN) | Long | 890 | 906 |
| | Trans | 4800 | 4788 |

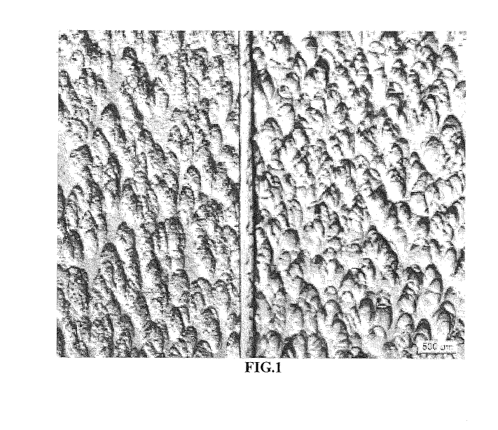

The size and shape of the bubbles were also observed with a binocular magnifier and the results obtained are very similar as can be seen in FIG. 1 (the right-hand part represents the film of example 3, the left-hand part that of example 4).

The pressure-sensitive adhesive films of examples 3 and 4, applied to a pre-lacquered motor vehicle sheet of polyurethane type, have, one hour after having been applied, an adhesive level measured by a peel force (measurement by an Instron-type tensile tester at 300 mm/min and 180°, measurement adapted from the AFERA 5001 standard), of about 215 cN/cm.

### EXAMPLE 5

### Adhesive Film Composed of an Acrylic-Coated Three-Layer Support

An adhesive film having a thickness of 74 μm was prepared in the following manner. Firstly, a support film was manufactured using three-layer blown-film coextrusion equipment. The following were thus introduced:
into extruder no. 1, a C8 linear polyethylene having a density of 0.919 and a flow index of 1.1;
into extruder no. 2, a 70/19/15/1 mixture by weight of linear polyethylene having a density of 0.924 and a flow index of 1, of linear polyethylene (comonomer: butene) having a density of 0.918 and a flow index of 1, of nucleating agent ME50024 (Multibase) and of antioxidant Polybatch UV1952 (Schulman); this intermediate layer was 16% expanded by injection of nitrogen in the supercritical fluid state into the mixture; and
into extruder no. 3, a radical polyethylene having a density of 0.924 and a flow index of 1.

An extrusion aid, the processing aid masterbatch POLYBATCH® NATURAL AMF 705 HF (A. Schulman), was used to facilitate the extrusion.

The extruded film thus obtained has a thickness of 70 microns. The surface intended to be in contact with the adhesive layer was then corona treated.

An adhesive composition was furthermore prepared by mixing:
100 parts by weight of acrylic dispersion (Acronal® DS3559), and
6 parts by weight of isocyanate crosslinker (Vestanat® IPDI (Degussa)),
   so as to obtain a solids content of 50% for the composition.

The isocyanate crosslinker was introduced into the dispersion in the form of a 25% premix in ethyl acetate.

The adhesive composition was coated on the support film under the standard conditions known to a person skilled in the art, so as to obtain a dry deposition of 4 g/m², equivalent to a thickness of 4 microns.

### EXAMPLES 6 AND 7

### Adhesive Films Composed of an Acrylic-Coated Three-Layer Support

Adhesive films having a thickness of 74 ym were prepared in the following manner. Firstly, a support film was manufactured using three-layer blown-film coextrusion equipment. The following were thus introduced:
into extruder no. 1, a C8 linear polyethylene having a density of 0.919 and a flow index of 1.1;
into extruder no. 2, a 70/19/15/1 mixture by weight of linear polyethylene having a density of 0.924 and a flow index of 1, of linear polyethylene (comonomer butene) having a density of 0.918 and a flow index of 1, of nucleating agent ME50024 (Multibase) and of antioxidant Polybatch UV1952 (Schulman); this intermediate layer was 34% and 54% expanded by injection of nitrogen in the supercritical fluid state into the mixture; and
into extruder no. 3, a C8 linear polyethylene having a density of 0.919 and a flow index of 1.1.

An extrusion aid, the processing aid masterbatch POLYBATCH® NATURAL AMF 705 HF (A. Schulman), was used to facilitate the extrusion.

The extruded films thus obtained have a thickness of 70 microns. The surface intended to be in contact with the adhesive layer was then corona treated.

An adhesive composition was furthermore prepared by mixing:
100 parts by weight of acrylic dispersion (Acronal® DS3559), and
6 parts by weight of isocyanate crosslinker (Vestanat® IPDI (Degussa)),
   so as to obtain a solids content of 50% for the composition.

The isocyanate crosslinker was introduced into the dispersion in the form of a 25% premix in ethyl acetate.

The adhesive composition was coated on the support films under the standard conditions known to person skilled in the art, so as to obtain a dry deposition of 4 g/m=, equivalent to a thickness of 4 microns.

### Film Properties

The characteristics of the non-coated films of examples 5 to 7 are presented in table 4. The mechanical properties were measured using Instron equipment. The initiated tear strength was measured using an ED 30/32 (TMI) tear tester according to the NF EN ISO 6383-2 standard. The elongation at break, the force at break and the tear strength were measured in the longitudinal direction and in the transverse direction of the films. The roughness of the films was measured using a HOMMEL TESTER T1000 roughness meter.

TABLE 4

| | | Ex. 5 | Ex. 6 | Ex. 7 |
|---|---|---|---|---|
| | | (70 μm) | (70 μm) | (70 μm) |
| Rz* (μm) | | 6 | 13 | 18 |
| Tear strength (mN) | Long | 3500 | 5100 | 3000 |
| | Trans | 7300 | 16000 | 11700 |
| Elongation at break | Long | 230 | 270 | 200 |
| (%) | Trans | 240 | 215 | 150 |
| Force at break | Long | 0.7 | 0.4 | 0.4 |
| (daN/cm) | Trans | 0.4 | 0.3 | 0.2 |

*measured on the side not corona treated

The pressure-sensitive adhesive films of examples 5 to 7, applied to a structured polycarbonate sheet, have, one hour after having been applied, adhesive levels measured by a peel force (measurement by an Instron-type tensile tester at 300 mm/min and 180°, measurement adapted from the AFERA 5001 standard), of about 130 cN/cm.

### EXAMPLE 8

### Adhesive Film Composed of a Rubber-Coated Three-Layer Support

An adhesive film having a thickness of 110 μm was prepared in the following manner. Firstly, a support film was manufactured using three-layer blown-film coextrusion equipment. The following were thus introduced:
into extruder no. 1, a 98/2 mixture by weight of radical polyethylene having a density of 0.924 and a flow index of 0.7 and of an antiblocking masterbatch ABPE 50N (Polytechs);
into extruder no. 2, an 85/14/1 mixture by weight of radical polyethylene having a density of 0.924 and a flow index of 0.7, of a white coloring agent (TiO₂), CL8000 (A. Schulman) and of antioxidant Polybatch UV1952 (A. Schulman); this intermediate layer was 50% expanded by injection of nitrogen in the supercritical fluid state into the mixture; and
into extruder no. 3, an 84/12/2 mixture by weight of radical polyethylene having a density of 0.924 and a flow index of 0.7, of a black coloring agent (carbon black), 1423HF1 (A. Schulman), and of an antiblocking masterbatch ABPE SON (Polytechs).

An extrusion aid, the processing aid masterbatch POLYBATCH® NATURAL AMF 705 HF (A. Schulman), was used to facilitate the extrusion.

The extruded film thus obtained has a thickness of 98 microns for a total spread of 75 g/m². The surface intended to be in contact with the adhesive layer was then corona treated. A polyvinyl octadecyl carbamate “release” varnish composition was coated on the second, corona-pretreated, face of the support film under the standard conditions known to person skilled in the art, so as to obtain a monomolecular layer.

The extruded film has, on the side to be coated with varnish, an Ra of 1.7 μm (±0.10 μm) and an Rz of 8.8 μm (±0.6 μm) measured using a HOMMEL TESTER T1000 roughness meter.

An adhesive composition was furthermore prepared by mixing, in gasoline:
100 parts by weight of CV50 SMR (standard Malaysian rubber) natural rubber,
120 parts by weight of Wingtack 86 (Cray Valley) tackifying resin,
3 parts by weight of Irganox 1010 (Ciba) antioxidant,
1.5 parts by weight of Tinuvin 770DF (BASF) anti-aging agent,
7 parts by weight of Desmodur N3600 (Bayer) crosslinker.

The adhesive composition was coated on the support film under the standard conditions known to person skilled in the art, so as to obtain a dry deposition of 12 g/m², equivalent to a thickness of 12 microns.

### COMPARATIVE EXAMPLES 3 AND 4

### Adhesive Films Composed of a Rubber-Coated Three-Layer Support

The protocol of example 8 was repeated but without expansion of the intermediate layer originating from extruder no. 2. The non-coated films had a respective thickness of 98 microns (comp. ex. 3) and 68 microns (comp. ex. 4).

### Film Properties

The characteristics of the films of example 8 and of comparative examples 3 and 4 are presented in table 5. The mechanical properties were measured using Instron equipment. The initiated tear strength was measured using an ED 30/32 (TMI) tear tester according to the NF EN ISO 6383-2 standard. The elongation at break, the force at break and the tear strength were measured in the longitudinal direction and in the transverse direction of the film.

TABLE 5

| | | Ex. 8 | Comp. Ex. 3 | Comp. Ex. 4 |
|---|---|---|---|---|
| | | (98 μm) | (98 μm) | (68 μm) |
| Elongation at break | Long | 360 | 632 | 234 |
| (%) | Trans | 300 | 462 | 477 |
| Force at break | Long | 0.92 | 2.27 | 1.37 |
| (daN/cm) | Trans | 0.75 | 2.31 | 1.11 |
| Young's modulus | | 162 | 224 | 159 |
| (N/mm²) | | | | |
| Tear strength (mN) | Long | 3500 | 3351 | 3289 |
| | Trans | 20000 | 6907 | 5671 |

It is observed that the mechanical properties of the film of the invention are not degraded and are intermediate to those of the films of comparative examples 3 and 4.

The pressure-sensitive adhesive film of example 8 also has an initial peel force, and after aging in an oven for 20 min at 100° C., of 191 cN/cm (measurement by an Instron-type tensile tester at 300 mm/min and 180°, protocol adapted from the AFERA 5001 standard). This peel force is greater than that of the adhesive film of comparative example 3, which has an initial peel force of 156 cN/cm (measurement by an Instron-type tensile tester at 300 mm/min and 180°, protocol adapted from the AFERA 5001 standard).

The noise measurement measured at 150 m/min using a CIRRUS Optimus CR 162C sound level meter is improved: 101 dB are measured (reel with a width of 2000 mm) for the adhesive film of example 8 whereas the noise of the control reel (comparative example 3) is measured at more than 105 dB.

The unwinding force is also improved: at 150 m/min, a force of 68 cN/cm (example 8) is measured versus 98 cN/cm for the control reel (comparative example 3).

### EXAMPLE 9

### Adhesive Film Composed of an Acrylic-Coated Three-Layer Support

An adhesive film having a thickness of 118 μm was prepared in the following manner. Firstly, a support film was manufactured using three-layer blown-film coextrusion equipment. The following were thus introduced:
into extruder no. 1, a 98/2 mixture by weight of a radical polyethylene having a density of 0.924 and a flow index of 0.7 and of an antiblocking masterbatch ABPE 50N (Polytechs);
into extruder no. 2, a 65/20/14/1 mixture by weight of radical polyethylene having a density of 0.924 and a flow index of 0.7, of linear polyethylene (comonomer: butene) having a density of 0.918 and a flow index of 1, of a white coloring agent (TiO₂), CL8000 (A. Schulman) and of antioxidant Polybatch UV1952 (A. Schulman); this intermediate layer was 50% expanded by injection of nitrogen in the supercritical fluid state into the mixture; and
into extruder no. 3, a 97/2/1 mixture by weight of radical polyethylene having a density of 0.924 and a flow index of 0.7, of an antiblocking masterbatch ABPE 50N (Polytechs) and of antioxidant Polybatch UV1952 (A. Schulman).

An extrusion aid, the processing aid masterbatch POLYBATCH® NATURAL AMF 705 HF (A. Schulman), was used to facilitate the extrusion.

The extruded film thus obtained has a thickness of 98 microns for a total spread of 75 g/m². The surface intended to be in contact with the adhesive layer was then corona treated.

The extruded film has, on the side not corona treated, an Ra of 2 μm (±0.2 μm) and an Rz of 10 μm (±0.8 μm) measured using a HOMMEL TESTER T1000 roughness meter.

The characteristics of this film are very similar to those of the film of example 8, as may be seen on reading table 6 below.

TABLE 6

| | | Ex. 9 |
|---|---|---|
| | | (98 μm) |
| Elongation at break | Long | 546 |
| (%) | Trans | 444 |
| Force at break | Long | 1.54 |
| (daN/cm) | Trans | 0.72 |
| Young's modulus | | 158 |
| (N/mm²) | | |
| Tear strength (mN) | Long | 1195 |
| | Trans | 21162 |

An adhesive composition was furthermore prepared by mixing:
100 parts by weight of acrylic dispersion (Acronal® DS3559), and
3 parts by weight of isocyanate crosslinker (Vestanat® IPDI (Degussa)),
   so as to obtain a solids content of 50% for the composition.

The isocyanate crosslinker was introduced into the dispersion in the form of a 25% premix in ethyl acetate.

The adhesive composition was coated on the support film under the standard conditions known to person skilled in the art, so as to obtain a dry deposition of 20 g/m², equivalent to a thickness of 20 microns.

The pressure-sensitive adhesive film thus obtained, applied to a pre-lacquered motor vehicle sheet of polyurethane type, has, one hour after having been applied, an adhesive level measured by a peel force (measurement by an Instron-type tensile tester at 300 mm/min and 180°, measurement adapted from the AFERA 5001 standard), of about 220 cN/cm.

### EXAMPLE 10

### Adhesive Film Composed of an Acrylic-Coated Three-Layer Support

An adhesive film having a thickness of 80 μm was prepared in the following manner. Firstly, a support film was manufactured using three-layer blown-film coextrusion equipment. The following were thus introduced:
into extruder no. 1, a radical polyethylene having a density of 0.924 and a flow index of 1;
into extruder no. 2, an 80/19/1 mixture by weight of radical polyethylene having a density of 0.924 and a flow index of 1, of linear polyethylene (comonomer. butene) having a density of 0.918 and a flow index of 1, and of antioxidant Polybatch UV1952 (Schulman); this intermediate layer was 50% expanded by injection of nitrogen in the supercritical fluid state into the mixture; and
into extruder no. 3, a radical polyethylene having a density of 0.924 and a flow index of 1.

An extrusion aid, the processing aid masterbatch POLYBATCH® NATURAL AMF 705 HF (A. Schulman), was used to facilitate the extrusion.

The extruded film thus obtained has a thickness of 76 microns for a total spread of 58 g/m². The surface intended to be in contact with the adhesive layer was then corona treated.

The extruded film has, on the side not corona treated, an Ra of 1.5 μm (±0.15 μm) and an Rz of 8 μm (±0.8 μm) measured using a HOMMEL TESTER T1000 roughness meter.

The characteristics of this film are the following:
Elongation at break (%): long. direction >150%, trans. direction >200%;
Force at break (daN/cm): long. direction >0.7, trans. direction >0.5.

An adhesive composition was furthermore prepared by mixing:
100 parts by weight of acrylic dispersion (Acronal® DS3559), and
6 parts by weight of isocyanate crosslinker (Vestanat® IPDI (Degussa)),
   so as to obtain a solids content of 50% for the composition.

The isocyanate crosslinker was introduced into the dispersion in the form of a 25% premix in ethyl acetate.

The adhesive composition was coated on the support film under the standard conditions known to person skilled in the art, so as to obtain a dry deposition of 4 g/m², equivalent to a thickness of 4 microns.

The pressure-sensitive adhesive film thus obtained, applied to a structured polycarbonate sheet, has, one hour after having been applied, an adhesive level measured by a peel force (measurement by an Instron-type tensile tester at 300 mm/min and 180°, measurement adapted from the AFERA 5001 standard), of about 130 cN/cm.

1. A pressure-sensitive adhesive film that comprises a support coated with a pressure-sensitive adhesive, said support comprising at least one expanded polyolefin layer, said polyolefin being selected from the group consisting of a radical low-density polyethylene, a linear polyethylene, polypropylene, a copolymer of ethylene and propylene, and a mixture of these compounds, said expanded layer comprising one or more additives selected from the group consisting of matting agents, slip agents; colorants; UV stabilizers; UV barriers; antioxidants; and anti-aging agents.

2. The pressure-sensitive adhesive film of claim 1, wherein the radical low-density polyethylene has a density in the range from 0.910 to 0.930, and a flow index in the range from 0.3 to 10 dg/min; the linear polyethylene has a density in the range from 0.858 to 0.961 and a flow index in the range from 0.05 to 10 dg/min; the polypropylene has a density in the range from 0.860 to 0.920, and a flow index in the range from 0.3 to 10 dg/min; and the copolymer of ethylene and propylene has a density in the range from 0.860 to 0.910 and a propylene content in the range from 25 to 60% by weight.

3. The pressure-sensitive adhesive film of claim 1, wherein the expanded layer comprises one or more additives selected from the group consisting of antiblocking agents, colorants and antioxidants.

4. The pressure-sensitive adhesive film of claim 1, wherein the support is a single-layer support.

5. The pressure-sensitive adhesive film of claim 1, wherein the support is a multilayer support.

6. The pressure-sensitive adhesive film of claim 5, wherein the support comprises an odd number of layers, and at least the central layer of the support essentially consists of expanded polyolefin.

7. The pressure-sensitive adhesive film of claim 6, wherein the layer(s) of the support which is (are) not expanded, consist(s) essentially of a polyolefin, of a synthetic rubber, of a copolymer of ethylene and vinyl acetate, or of a mixture of these compounds.

8. The pressure-sensitive adhesive film of claim 7, wherein the layer(s) of the support which is (are) not expanded, consist(s) essentially of a polyolefin selected from the group consisting of a radical polyethylene having a density in the range from 0.910 to 0.930 and a flow index in the range from 0.3 to 10 dg/min; a linear polyethylene having a density in the range from 0.858 to 0.961 and a flow index in the range from 0.05 to 10 dg/min; a polypropylene having a density in the range from 0.860 to 0.920 and a flow index in the range from 0.3 to 10 dg/min; a copolymer of ethylene and propylene having a density in the range from 0.860 to 0.910 and having a propylene content in the range from 25 to 60% by weight; and mixtures of these compounds.

9. The pressure-sensitive adhesive film of claim 1, wherein the pressure-sensitive adhesive is an acrylic adhesive or a rubber adhesive.

10. The pressure-sensitive adhesive film of claim 9, wherein the adhesive is crosslinked.

11. The pressure-sensitive adhesive film of claim 1, wherein the adhesive is coated on the support in an amount of 0.5 to 25 g/m².

12. The pressure-sensitive adhesive film claim 1, wherein the support is plasma treated or corona treated before the application of the adhesive.

13. The pressure-sensitive adhesive film of claim 1, wherein the support has, on both sides, a surface roughness R_{A} in the range from 0.05 to 6 μm.

14. The pressure-sensitive adhesive film of claim 1, wherein the support has a tear strength greater than or equal to 250 mN in the longitudinal direction of the film.

15. (canceled)

16. The pressure-sensitive adhesive film of claim 5, wherein the support comprises 3, 5, 7 or 9 layers.

17. The pressure-sensitive adhesive film of claim 11, wherein the adhesive is coated on the support in an amount of 0.5 to 20 g/m².

18. The pressure-sensitive adhesive film of claim 17, wherein the adhesive is coated on the support in an amount of 0.5 to 16 g/m².

19. A method for temporarily protecting a surface, which comprises applying to said surface a pressure-sensitive adhesive film of claim 1.
